(19) United States
(12) Patent Application Publication
(10) Pub. No.: US 2026/0074099 A1
(43) Pub. Date: Mar. 12, 2026

(54) SOFT-MAGNETIC METAL POWDER, PRODUCTION METHOD FOR SAME, AND RESIN COMPOSITION

(71) Applicants: TODA KOGYO CORP., Hiroshima-shi (JP); TOHOKU UNIVERSITY, Sendai-shi (JP)

(72) Inventors: Rei TSUSHIRO, Otake-shi (JP); Yasushi NISHIO, Otake-shi (JP); Yasushi ENDO, Sendai-shi (JP)

(73) Assignees: TODA KOGYO CORP., Hiroshima-shi (JP); TOHOKU UNIVERSITY, Sendai-shi (JP)

(21) Appl. No.: 19/106,386

(22) PCT Filed: Aug. 28, 2023
(86) PCT No.: PCT/JP2023/030897

§ 371 Date: Jul. 11, 2025

(30) Foreign Application Priority Data
Aug. 31, 2022 (JP) 2022-137706

(51) Int. Cl. H01F 1/147; B22F 1/05; B22F 1/054; B22F 9/24; C08K 3/08; C22C 38/00

(52) U.S. Cl. CPC H01F 1/14741; B22F 1/05; B22F 1/056; B22F 9/24; C08K 3/08; C22C 38/002; B22F 2304/056; B22F 2304/10; B22F 2999/00; C08K 2003/0856; C08K 2201/005; C08K 2201/01; C08K 2201/011; C22C 2202/02

(57) ABSTRACT

A soft magnetic metal powder contains 5.0% by weight or more and 10.0% by weight or less of B, the balance being one or more metals selected from Fe, Ni, and Co. The soft magnetic metal powder has an average primary particle size of 0.05 μm or more and 1.5 μm or less, a coefficient of variation (standard deviation of primary particle size/average primary particle size) of 0.25 or less, and an aggregation ratio (average aggregate particle size/average primary particle size) of 3 or less.

### TECHNICAL FIELD

The present invention relates to a soft magnetic metal powder. Specifically, the soft magnetic metal powder relates to a soft magnetic metal powder that is composed of fine particles but does not readily aggregate and has good dispersibility, that is spherical and excellent in packing factor and dispersibility in a resin or the like, and that has a narrow particle size distribution range and a uniform primary particle size and can thus be used to prepare a magnetic material having excellent magnetic characteristics at a desired frequency and a high Q value in a radio frequency band of 1 GHz or more.

### BACKGROUND ART

As various electrical devices have achieved higher functionality and have become smaller and thinner, there is a need for elements, such as inductors and transformers, with reduced thicknesses as well as improved magnetic characteristics for incorporation into electrical devices.

In addition, AI and device automation have necessitated high-speed communication and high responsiveness, and there is a need for the development of a magnetic material for inductors, noise suppression components, and the like compatible with radio frequencies.

In the field of elements for use at radio frequencies, particularly in the GHz band, there is a need for the development of a magnetic material with a high Q value (Q value=μ′/μ″), where the Q value is the ratio of the real part (μ′) of magnetic permeability to the imaginary part (μ″) of magnetic permeability.

Whereas a typical magnetic material that has been conventionally used for inductors is ferrite, metallic materials with higher saturation magnetic flux density have recently attracted attention because of higher currents due to automation.

Fine magnetic powders having a uniform particle size distribution are required to improve and stabilize the magnetic characteristics of magnetic materials such as those for inductors.

A collection of soft magnetic metal powder fine particles that have a uniform primary particle size and do not readily aggregate can be expected to improve and stabilize the magnetic characteristics of magnetic materials.

However, submicron-sized fine particles have a problem in that they readily aggregate and are not easy to mix in a resin or the like.

One method for preparing a soft magnetic metal powder composed of fine particles is a liquid-phase reduction method as described in PTL 1 described below.

However, a conventional liquid-phase reduction method has a problem in that the resulting particles form aggregates or have a nonuniform primary particle size.

Because particle size distribution is closely related to frequency characteristics, a soft magnetic metal powder having a nonuniform primary particle size and a broad particle size distribution may have insufficient magnetic characteristics in the desired radio frequency band.

Thus, there is a problem for industrial use in that it is necessary to disintegrate aggregated particles or remove metal fine particles other than those having the required primary particle size by classification.

Methods that involve no liquid-phase reaction, such as an atomization method, a carbonyl decomposition method, and a spray pyrolysis method, also have a problem in that the resulting particles form aggregates or have a nonuniform primary particle size.

Accordingly, it has been desirable to develop a soft magnetic metal powder that is composed of fine particles but can be readily dispersed without aggregation and can be packed in a resin or the like and that has a uniform primary particle size and can thus be used to prepare a magnetic material having excellent magnetic characteristics at radio frequencies.

### CITATION LIST

### Patent Literature

PTL 1: Japanese Unexamined Patent Application Publication No. 2010-261065

### SUMMARY OF INVENTION

### Technical Problem

PTL 1 describes a method for preparing a soft magnetic metal powder having a smaller particle size than conventional soft magnetic metal powders by a liquid-phase reduction method in which a reductant solution containing a boron (B)-based reductant is added dropwise to an iron salt aqueous solution containing an iron salt, a complexing agent, a dispersant, a pH adjuster, and a phosphorus (P)-based reductant.

However, the method of manufacture described in PTL 1 has a problem in that the resulting particles form aggregates or have a nonuniform primary particle size.

After conducting trial manufacture and experimentation many times by trial and error in order to solve the above various problems, which is a technical object, the inventors have made the remarkable finding that a soft magnetic metal powder that contains 5.0% by weight or more and 10.0% by weight or less of B, the balance being one or more metals selected from iron (Fe), nickel (Ni), and cobalt (Co), and that has an average primary particle size of 0.05 μm or more and 1.5 μm or less, a coefficient of variation (standard deviation of primary particle size/average primary particle size) of 0.25 or less, and an aggregation ratio (average aggregate particle size/average primary particle size) of 3 or less is composed of fine particles but does not readily aggregate and has good dispersibility, is spherical and thus excellent in packing factor, and has a narrow particle size distribution and a uniform primary particle size and can thus be used to prepare a magnetic material having excellent magnetic characteristics in a radio frequency band, thus achieving the above technical object.

### Solution to Problem

The above technical object can be achieved by the present invention as follows.

The present invention is a soft magnetic metal powder containing 5.0% by weight or more and 10.0% by weight or less of B, the balance being one or more metals selected from Fe, Ni, and Co. The soft magnetic metal powder has an average primary particle size of 0.05 μm or more and 1.5 μm or less, a coefficient of variation expressed by the following (expression 1) of 0.25 or less, and an aggregation ratio expressed by the following (expression 2) of 3 or less:

$$standard deviation ( σ ) of primary particle size \text{} / average primary particle size ( D 1 ) \qquad ( expression 1 )$$

$$average aggregate particle size ( D 2 ) / average primary particle size ( D 1 ) \qquad ( expression 2 )$$

The present invention is also the soft magnetic metal powder, wherein the soft magnetic metal powder has an oxygen (O) content of less than 8.0% by weight.

The present invention is also a resin composition containing the soft magnetic metal powder.

The present invention is also a method for manufacturing the soft magnetic metal powder, including manufacturing the soft magnetic metal powder by a liquid-phase reduction method in which a reductant solution containing a B-based reductant is added dropwise to an aqueous solution of one or more metal salts selected from Fe, Ni, and Co salts.

### Advantageous Effects of Invention

The present invention is a soft magnetic metal powder that is composed of fine particles but does not readily aggregate and has excellent dispersibility and that has a uniform primary particle size and thus has excellent magnetic characteristics.

Because the soft magnetic metal powder has a narrow primary particle size distribution range, it exhibits a high Q value in a radio frequency band of 1 GHz or more.

In addition, when the soft magnetic metal powder has an O content of less than 8.0% by weight, a decrease in saturation magnetization due to an oxide film can be reduced.

In addition, the resin composition containing the soft magnetic metal powder of the present invention can be used to prepare a magnetic material having excellent magnetic characteristics.

In particular, because the soft magnetic metal powder of the present invention is composed of fine particles having an average primary particle size of 0.05 μm or more and 1.5 μm or less, an eddy current in the particles is reduced. This is effective for a magnetic material for use in a radio frequency band because there is a tendency for the eddy current loss of a soft magnetic metal powder to increase in proportion to the square of the drive frequency.

Thus, the soft magnetic metal powder of the present invention is suitable for use in small inductors for radio frequencies and noise suppression components.

### BRIEF DESCRIPTION OF DRAWINGS

FIG. 1 is a SEM photograph (10000 times) of a soft magnetic metal powder of Example 1.

FIG. 2 is a SEM photograph (10000 times) of a soft magnetic metal powder of Example 2.

### DESCRIPTION OF EMBODIMENTS

A soft magnetic metal powder of the present invention is a collection of fine particles having a narrow primary particle size distribution.

The soft magnetic metal powder of the present invention preferably has an average primary particle size of 0.05 μm to 1.5 μm, more preferably 0.07 μm to 1.0 μm.

This is because when the soft magnetic metal powder has an average primary particle size of less than 0.05 μm, the saturation magnetization decreases due to an increased proportion of an oxide film on the surface of the particles, whereas when the soft magnetic metal powder has an average primary particle size of more than 1.5 μm, the eddy current loss at radio frequencies increases.

To reduce a decrease in saturation magnetization due to an oxide film, the soft magnetic metal powder preferably has an O content of less than 8.0% by weight, more preferably 6.2% by weight or less.

The lower limit of the O content of the soft magnetic metal powder is 0.05% by weight.

The soft magnetic metal powder of the present invention preferably has a coefficient of variation of primary particle size expressed by (expression 1) of 0.25 or less, more preferably 0.23 or less, even more preferably 0.16 or less.

$$standard deviation ( σ ) of primary particle size \text{} / average primary particle size ( D 1 ) \qquad ( expression 1 )$$

When the soft magnetic metal powder has a coefficient of variation of more than 0.25, it may be impossible to achieve a sufficient Q value in a radio frequency band when the powder is used for small electronic components for radio frequencies.

The lower limit value of the coefficient of variation is about 0.001.

The soft magnetic metal powder of the present invention preferably has an aggregation ratio expressed by (expression 2) of 3 or less, more preferably 2.7 or less, even more preferably 2.5 or less.

$$average aggregate particle size ( D 2 ) / average primary particle size ( D 1 ) \qquad ( expression 2 )$$

When the soft magnetic metal powder has an aggregation ratio of more than 3, it may be impossible to achieve a sufficient Q value in a radio frequency band when the powder is used for small electronic components for radio frequencies.

In addition, when the soft magnetic metal powder has an aggregation ratio of more than 3, its dispersibility in a resin or the like may decrease.

Fine particles having a uniform particle size and a low degree of aggregation may have an aggregation ratio of less than 1.

The lower limit value of the aggregation ratio in the present invention is about 0.3.

The primary particle size of the soft magnetic metal powder can be determined by capturing an image under a scanning electron microscope (SEM) at a magnification of 2000 times to 10000 times and measuring the primary particle size using image analysis software.

The soft magnetic metal powder of the present invention preferably has a B content of 5.0% by weight to 10.0% by weight, more preferably 5.2% by weight to 9.0% by weight, even more preferably 5.8% by weight to 8.0% by weight.

When the soft magnetic metal powder has a B content of more than 10.0% by weight, it may be impossible to achieve sufficient magnetic characteristics because the saturation magnetization (σs) decreases due to a decreased magnetic element content.

On the other hand, when the soft magnetic metal powder has a B content of less than 5.0% by weight, the eddy current loss at radio frequencies may increase because the powder becomes crystalline.

In addition, the magnetic characteristics in the desired radio frequency band may deteriorate because an increased amount of nonspherical fine particles are formed in a method of manufacture using a liquid-phase reduction method unless a composition having a B-based reduction action is used.

The shape of the soft magnetic metal powder is preferably, but not particularly limited to, a spherical shape from the viewpoint of improvements in dispersibility and packing factor in a resin or the like.

The soft magnetic metal powder preferably has a σs of 120 Wb·m/kg or more, more preferably 130 Wb·m/kg or more, even more preferably 140 Wb·m/kg or more.

The soft magnetic metal powder preferably has a coercive force (Hc) of 10 kA/m or less, more preferably 5 kA/m or less, even more preferably 3 kA/m or less.

The soft magnetic metal powder of the present invention may be coated with a metal oxide. This is because an improved insulation effect can be expected.

Next, a method for manufacturing the soft magnetic metal powder according to the present invention will be described.

The soft magnetic metal powder of the present invention can be manufactured by a liquid-phase reduction method in which an aqueous solution of one or more metal salts selected from Fe, Ni, and Co salts is reduced with a B-based reductant.

Examples of iron salts include, but not limited to, iron (II) sulfate, iron (II) chloride, iron (II) acetate, iron (II) oxalate, iron (III) chloride, and iron (III) sulfate.

Examples of nickel salts include, but not limited to, nickel (II) chloride, nickel (II) sulfate, nickel (II) nitrate, and nickel (III) fluoride.

Examples of cobalt salts include, but not limited to, cobalt (II) chloride, cobalt (II) sulfate, and cobalt (II) nitrate.

The metal salt aqueous solution may contain a complexing agent and a non-B-based reductant.

Examples of complexing agents include, but not particularly limited to, glycine, alanine, ammonium sulfate, ammonium chloride, and trisodium citrate.

The non-B-based reductant is not particularly limited, and a P-based reductant may be used.

Examples of P-based reductants include, but not limited to, sodium hypophosphite and calcium hypophosphite.

The metal salt aqueous solution need not necessarily contain the P-based reductant.

The soft magnetic metal powder of the present invention preferably has a P content of 2.0% by weight or less. When the soft magnetic metal powder has a P content of more than 2.0% by weight, it may be impossible to achieve sufficient magnetic characteristics because σs decreases due to a decreased magnetic element content.

The pH of the metal salt aqueous solution is preferably adjusted to 6.5 to 11.0 with a pH adjuster.

Examples of pH adjusters include, but not particularly limited to, sodium hydroxide, aqueous ammonia, and sodium hydrogen carbonate.

The metal salt aqueous solution may contain a dispersant, a catalyst, and a defoamer as appropriate.

A B-based reductant is used as a reductant for reducing the metal salt aqueous solution.

Examples of B-based reductants include sodium borohydride, potassium borohydride, and dimethylaminoborane.

Hydrazine, which does not contain B, may be used in combination with the B-based reductant.

The amount of B-based reductant added is preferably 15% by weight to 60% by weight based on the amount of metal salt.

When the amount of B-based reductant added is less than 15% by weight, the eddy current loss at radio frequencies may increase because the powder becomes crystalline. When the amount of B-based reductant added is more than 60% by weight, it may be impossible to achieve sufficient magnetic characteristics because σs decreases due to a decreased magnetic element content.

The reduction temperature is preferably 10° C. to 95° C.

When the reduction temperature is lower than 10° C., the particle size increases, and the desired size cannot be achieved. In addition, such a reduction temperature is industrially undesirable due to an increased cooling cost. When the reduction temperature is higher than 95° C., it may be impossible to obtain the soft magnetic metal powder of the present invention due to accelerated deactivation of the reductant.

The soft magnetic metal powder of the present invention can be mixed with a resin to prepare a resin composition.

The resin composition can be used to prepare a magnetic material for inductors, magnetic sheets, and the like.

The type of resin is not particularly limited and may be selected as appropriate depending on the use and the required heat resistance.

Examples of resins include thermoplastic resins such as epoxy resins, phenol resins, silicone resins, polyamideimide resins, unsaturated polyester resins, diallyl phthalate resins, xylene resins, polyester-based resins, polyvinyl chloride-based resins, polyvinyl butyral resins, polyurethane resins, cellulose-based resins, nitrile-butadiene-based rubbers, and styrene-butadiene-based rubbers, and thermosetting resins such as epoxy resins, phenol resins, amide-based resins, and imide-based resins.

The content of the soft magnetic metal powder in the resin composition is not particularly limited and may be varied as appropriate depending on the desired physical properties such as flexibility and the desired magnetic characteristics such as the Q value. The content of the soft magnetic metal powder in the resin composition is preferably 10% by volume to 90% by volume, more preferably 15% by volume to 85% by volume, even more preferably 20% by volume to 80% by volume.

The resin composition containing the soft magnetic metal powder preferably has a higher Q value because the power efficiency can be improved.

The resin composition preferably has a Q value at 1 GHZ of 5 or more, more preferably 7 or more, even more preferably 10 or more. The resin composition containing the soft magnetic metal powder of the present invention can also achieve a Q value of 10 or more.

This is because highly packed fine particles having superior magnetic characteristics allow the product of the Q value and √(D1) to be increased and can thus be expected to provide characteristics suitable as a magnetic material for radio frequencies.

Q value×√(D1) at 1 GHz is preferably 5 or more, more preferably 6 or more, even more preferably 7 or more.

### EXAMPLES

The present invention will be described with reference to the Examples and the Comparative Examples, although the present invention is not limited to these examples.

### Example 1

Iron (II) sulfate heptahydrate, glycine, and sodium hypophosphite were fed into a glass beaker together with 600 ml of distilled water in concentrations of 0.20 mol/l, 0.10 mol/l, and 0.20 mol/l, respectively. Sodium hydroxide was used to adjust the pH to 7.5 to 9.5 at room temperature with stirring using a stirrer at 100 rpm to 300 rpm to prepare a metal salt aqueous solution.

Sodium borohydride was mixed with 200 ml of distilled water in a concentration of 0.50 mol/l and was dissolved at room temperature with stirring using a stirrer at 100 rpm to 300 rpm to prepare a reductant solution.

The reductant solution was added dropwise to the metal salt aqueous solution at 50° C. in a nitrogen atmosphere with stirring using a stirrer at 100 rpm to 300 rpm.

The point in time when there was no bubbling in the metal salt aqueous solution was determined to be the endpoint of the reduction reaction.

After the completion of the reduction reaction, the reaction product was rinsed with distilled water, followed by replacement with an alcohol and drying in an inert atmosphere of nitrogen gas to obtain a soft magnetic metal powder.

### Example 2

Iron (II) sulfate heptahydrate, glycine, ammonium sulfate, and sodium hypophosphite were fed into a glass beaker together with 600 ml of distilled water in concentrations of 0.20 mol/l, 0.10 mol/l, 0.20 mol/l, and 0.20 mol/l, respectively. Sodium hydroxide was used to adjust the pH to 9.0 to 11.0 at room temperature with stirring using a stirrer at 100 rpm to 300 rpm to prepare a metal salt aqueous solution.

Sodium borohydride was mixed with 200 ml of distilled water in a concentration of 0.30 mol/l and was dissolved at room temperature with stirring using a stirrer at 100 rpm to 300 rpm to prepare a reductant solution.

The reductant solution was added dropwise to the metal salt aqueous solution at 25° C. in a nitrogen atmosphere with stirring using a stirrer at 100 rpm to 300 rpm.

The point in time when there was no bubbling in the metal salt aqueous solution was determined to be the endpoint of the reduction reaction.

After the completion of the reduction reaction, the reaction product was rinsed with distilled water, followed by replacement with an alcohol and drying in an inert atmosphere of nitrogen gas to obtain a soft magnetic metal powder.

### Example 3

Iron (II) sulfate heptahydrate and ammonium sulfate were fed into a glass beaker together with 400 ml of distilled water in concentrations of 0.21 mol/l and 0.58 mol/l, respectively. Sodium hydroxide was used to adjust the pH to 9.0 to 11.0 at room temperature with stirring using a stirrer at 100 rpm to 300 rpm to prepare a metal salt aqueous solution.

Sodium borohydride was mixed with 400 ml of distilled water in a concentration of 0.22 mol/l and was dissolved at room temperature with stirring using a stirrer at 100 rpm to 300 rpm to prepare a reductant solution.

The reductant solution was added dropwise to the metal salt aqueous solution at 25° C. in a nitrogen atmosphere with stirring using a stirrer at 100 rpm to 300 rpm.

The point in time when there was no bubbling in the metal salt aqueous solution was determined to be the endpoint of the reduction reaction.

After the completion of the reduction reaction, the reaction product was rinsed with distilled water, followed by replacement with an alcohol and drying in an inert atmosphere of nitrogen gas to obtain a soft magnetic metal powder.

### Comparative Example 1

In accordance with the method disclosed in PTL 1, iron (II) chloride hydrate, ammonium chloride, trisodium citrate hydrate, polyvinylpyrrolidone, and sodium hypophosphite hydrate were fed together with 200 ml of distilled water in concentrations of 1.0 mol/l, 1.5 mol/l, 0.8 mol/1, 0.004 mol/l, and 1.5 mol/l, respectively, and a 30% sodium hydroxide aqueous solution was used to adjust the pH to 10 at room temperature with stirring using a stirrer at 160 rpm to 300 rpm to prepare a metal salt aqueous solution.

Sodium borohydride was mixed with 150 ml of distilled water in a concentration of 0.50 mol/l and was dissolved at room temperature with stirring using a stirrer at 160 rpm to 300 rpm to prepare a reductant solution.

The reductant solution was added dropwise to the metal salt aqueous solution at 25° C. with stirring using a stirrer at 160 rpm to 300 rpm.

The point in time when there was no bubbling in the metal salt aqueous solution was determined to be the endpoint of the reduction reaction.

After the completion of the reduction reaction, the reaction product was rinsed with distilled water, followed by replacement with an alcohol and drying in an inert atmosphere of nitrogen gas to obtain a soft magnetic metal powder.

### Comparative Example 2

Iron (II) sulfate heptahydrate and ammonium sulfate were fed into a glass beaker together with 400 ml of distilled water in concentrations of 0.21 mol/l and 1.93 mol/l, respectively. Sodium hydroxide was used to adjust the pH to 9.0 to 11.0 at room temperature with stirring using a stirrer at 100 rpm to 300 rpm to prepare a metal salt aqueous solution.

Sodium borohydride was mixed with 400 ml of distilled water in a concentration of 0.22 mol/l and was dissolved at room temperature with stirring using a stirrer at 100 rpm to 300 rpm to prepare a reductant solution.

The reductant solution was added dropwise to the metal salt aqueous solution at 20° C. in a nitrogen atmosphere with stirring using a stirrer at 100 rpm to 300 rpm.

The point in time when there was no bubbling in the metal salt aqueous solution was determined to be the endpoint of the reduction reaction.

After the completion of the reduction reaction, the reaction product was rinsed with distilled water, followed by replacement with an alcohol and drying in an inert atmosphere of nitrogen gas to obtain a soft magnetic metal powder.

The crystal structure of each resulting soft magnetic metal powder was evaluated using an X-ray diffractometer and was determined to be amorphous.

A silicone resin sheet containing 32% by volume of the soft magnetic metal powder obtained in Example 1 and resin sheets containing 40% by volume of the soft magnetic metal powders obtained in Examples 2 and 3 and Comparative Examples 1 and 2 were each fabricated and evaluated for the Q value at 1 GHz using a magnetic permeability measurement system.

### (Measurement of Primary Particle Size and Average Primary Particle Size)

An image was captured under a scanning electron microscope at 2000 times to 10000 times. The longest diameters of all particles in the field of view of the captured image were measured using the image analysis software A-Zou Kun (manufactured by Asahi Kasei Engineering Corporation) and were used to calculate the average primary particle size (D1) and then calculate the standard deviation (o) of the primary particle size.

From D1 and σ thus obtained, the coefficient of variation was calculated by using (expression 1).

$$standard deviation ( σ ) of primary particle size \text{} / average primary particle size ( D 1 ) \qquad ( expression 1 )$$

### (Measurement of Average Aggregate Particle Size)

The average aggregate particle size (D2) was measured using a particle size distribution analyzer (Microtrac MT3300EXII, manufactured by MicrotracBEL Corporation). The measurement range was from 0.02 μm to 2000 μm, and ethanol was used as a solvent for measurement.

From D2 and D1 thus obtained, the aggregation ratio was calculated by using (expression 2).

$$average aggregate particle size ( D 2 ) / average primary particle size ( D 1 ) \qquad ( expression 2 )$$

### (Crystal Structure)

A measurement was performed using an X-ray diffractometer (D8 ADVANCE, manufactured by Bruker Japan K.K.), and the crystal phase in the sample was determined.

### (Compositional Analysis <Fe, P>)

A measurement was performed using a fluorescent X-ray diffractometer (ZSX Primus II, manufactured by Rigaku Corporation) in accordance with JIS K 0119 “General rules for X-ray fluorescence analysis”.

### (Compositional Analysis <B>)

A measurement was performed using an inductively coupled plasma (ICP) spectrometer (iCAP 6500, manufactured by Thermo Fisher Scientific Inc.).

### (Compositional Analysis <O>)

A measurement was performed using an oxygen/nitrogen/hydrogen analyzer (EMGA-930, manufactured by Horiba, Ltd.).

### (Magnetic Characteristics <Saturation Magnetization (σs) and Coercive Force (Hc)>)

The saturation magnetization (σs) and coercive force (Hc) of the soft magnetic metal powders of the Examples and the Comparative Examples were measured using a vibrating sample magnetometer (VSM) (TM-VSM2130 MRHL type, manufactured by Tamagawa Co., Ltd.).

### (Magnetic Characteristics <Material Constants (μ′, μ″)>)

The real part μ′ of the magnetic permeability and the imaginary part μ″ of the magnetic permeability of sheet-shaped objects (resin sheets) formed of silicone resins (X-32-2100-T, manufactured by Shin-Etsu Chemical Co., Ltd.) containing 30% by volume to 40% by volume of the soft magnetic metal powders of the Examples and the Comparative Examples were measured at 0.1 GHz to 10 GHz using a magnetic permeability measurement system (N5230A, manufactured by Agilent Technologies), and the Q value was calculated as the ratio of the real part (μ′) of the magnetic permeability to the imaginary part (μ″) of the magnetic permeability at 1 GHz.

The materials and conditions used for the Examples and the Comparative Examples are shown in Table 1, and the results are shown in Table 2.

In Table 2, o denotes the standard deviation of the particle size, D1 denotes the average primary particle size, and D2 denotes the average aggregate particle size.

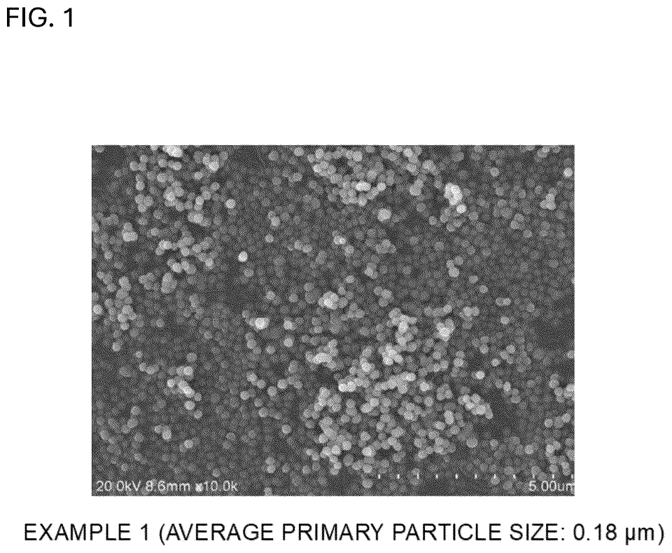

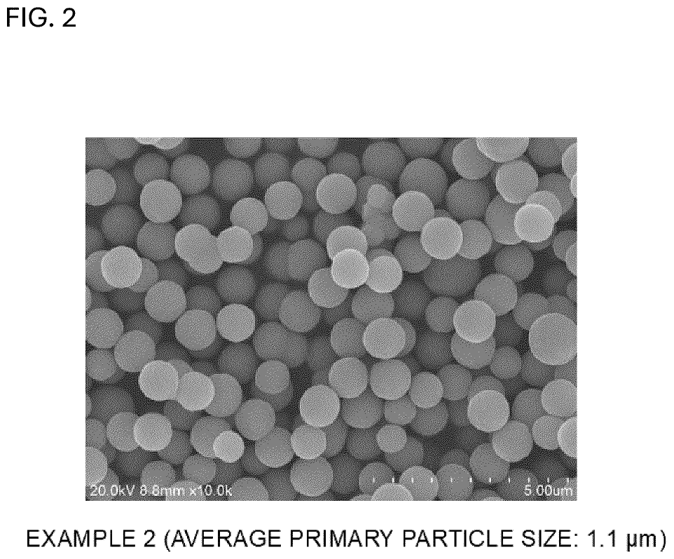

FIG. 1 and FIG. 2 show scanning electron microscope (SEM) photographs (10000 times) of the spherical soft magnetic metal powders obtained in Example 1 and Example 2, respectively.

TABLE 1

| | | Metal salt | | Complexing agent 1 | | | |
|---|---|---|---|---|---|---|---|
| | | | Amount | | Amount | Complexing agent 2 | |
| | | | Added | | Added | | Amount Added |
| | | Type | (mol/l) | Type | (mol/l) | Type | (mol/l) |
| Ex. | 1 | Iron(II) sulfate | 0.20 | Glycine | 0.10 | — | — |
| | 2 | Iron(II) sulfate | 0.20 | Glycine | 0.10 | Ammonium | 0.20 |
| | | | | | | sulfate | |
| | 3 | Iron(II) sulfate | 0.21 | Ammonium sulfate | 0.58 | — | — |
| Comp. | 1 | Iron(II) | 1.00 | Ammonium | 1.50 | Trisodium | 0.80 |
| Ex. | | chloride | | chloride | | citrate | |
| | 2 | Iron(II) | 0.21 | Ammonium sulfate | 1.93 | — | — |
| | | chloride | | | | | |

| | | Reductant 1 | | | | | |
|---|---|---|---|---|---|---|---|
| | | | Amount | Reductant 2 | | | Reduction |
| | | | Added | | Amount Added | pH adjuster | temperature |
| | | Type | (mol/l) | Type | (mol/l) | Type | (° C.) |
| Ex. | 1 | Sodium | 0.50 | Sodium hypophosphite | 0.20 | Sodium | 50 |
| | | borohydride | | | | hydroxide | |
| | 2 | Sodium | 0.30 | Sodium hypophosphite | 0.20 | Sodium | 25 |
| | | borohydride | | | | hydroxide | |
| | 3 | Sodium | 0.22 | — | — | Sodium | 25 |
| | | borohydride | | | | hydroxide | |
| Comp. | 1 | Sodium | 0.50 | Sodium hypophosphite | 1.50 | Sodium | 25 |
| Ex. | | borohydride | | | | hydroxide | |
| | 2 | Sodium | 0.22 | — | — | Sodium | 20 |
| | | borohydride | | | | hydroxide | |

TABLE 2

| | | Particle properties | | | | | | | | | | |
|---|---|---|---|---|---|---|---|---|---|---|---|---|
| | | Average | | | Compositional analysis | | | | | | | Magnetic |
| | | primary | | | results | | | | Magnetic characteristics | | | characteristics |
| | | particle size | | | Fe | B | P | O | σs | Hc | Q value | and shape |
| | | (μm) | σ/D1 | D2/D1 | (wt %) | (wt %) | (wt %) | (wt %) | (Wb · m/kg) | (kA/m) | (1 GHz) | Q*√(D1) |
| Ex. | 1 | 0.18 | 0.14 | 0.77 | 87 | 6.3 | 0.54 | 5.9 | 143 | 2.5 | 15 | 6.3 |
| | 2 | 1.1 | 0.12 | 1.2 | 90 | 7.1 | 0.28 | 2.9 | 155 | 0.48 | 11 | 11 |
| | 3 | 1.4 | 0.22 | 2.7 | 90 | 6.7 | 0.00 | 3.5 | 149 | 0.30 | 5.5 | 6.6 |
| Comp. | 1 | 1.0 | 0.36 | 7.2 | 85 | 7.9 | 0.80 | 6.6 | 134 | 1.8 | 2.7 | 2.7 |
| Ex. | 2 | 0.50 | 0.28 | 3.3 | 87 | 7.1 | 0.00 | 5.5 | 144 | 1.1 | 4.3 | 3.0 |

As can be seen from Table 2, FIG. 1, and FIG. 2, it was demonstrated that the soft magnetic metal powder of the present invention is spherical, has a uniform primary particle size and does not readily aggregate, and can be used to prepare a magnetic material having excellent magnetic characteristics at radio frequencies.

### INDUSTRIAL APPLICABILITY

The soft magnetic metal powder of the present invention is composed of fine particles but does not readily aggregate and has good dispersibility, is spherical, and has a narrow particle size distribution range and a uniform primary particle size and can thus be used to prepare a magnetic material having a high Q value in a radio frequency band of 1 GHz or more. Thus, the soft magnetic metal powder of the present invention is suitable for use in electronic components such as inductors that have excellent magnetic characteristics in a radio frequency band of 1 GHz or more. Accordingly, the present invention is an invention having high industrial applicability.

1. A soft magnetic metal powder, comprising:
5.0% by weight or more and 10.0% by weight or less of B,
the balance being one or more metals selected from Fe, Ni, and Co,
wherein
the soft magnetic metal powder has an average primary particle size of 0.05 μm or more and 1.5 μm or less, a coefficient of variation expressed by the following (expression 1) of 0.25 or less, and an aggregation ratio expressed by the following (expression 2) of 3 or less:
$$standard deviation of primary particle size \text{} / average primary particle size \qquad ( expression 1 )$$
$$average aggregate particle size / average primary particle size \qquad ( expression 2 )$$

2. The soft magnetic metal powder according to claim 1, wherein the soft magnetic metal powder has an O content of less than 8.0% by weight.

3. A resin composition comprising the soft magnetic metal powder according to claim 1.

4. A method for manufacturing the soft magnetic metal powder according to claim 1, comprising:
manufacturing the soft magnetic metal powder by a liquid-phase reduction method in which a reductant solution containing a B-based reductant is added dropwise to an aqueous solution of one or more metal salts selected from Fe, Ni, and Co salts.
